(19) United States
(12) Patent Application Publication
(10) Pub. No.: US 2015/0131665 A1
(43) Pub. Date: May 14, 2015

(54) Forwarding Database

(71) Applicant: Broadcom Corporation, Irvine, CA (US)

(72) Inventor: Mark David Griswold, Fremont, CA (US)

(73) Assignee: Broadcom Corporation, Irvine, CA (US)

(21) Appl. No.: 14/133,909

(22) Filed: Dec. 19, 2013

Related U.S. Application Data
(60) Provisional application No. 61/903,028, filed on Nov. 12, 2013.

(51) Int. Cl. H04L 12/741; H04L 12/745

(52) U.S. Cl. CPC H04L 45/745; H04L 45/748
USPC 370/392

(57) ABSTRACT

A system includes a network interface configured to receive a message comprising a routing address, and forward the message in accord with a route. The system further includes logic, operatively connected to the network interface. The logic is configured to apply a mask to the routing address to determine a masked address, and perform an exact match on the masked address.

### PRIORITY CLAIM

This application claims priority to U.S. Provisional Application Ser. No. 61/903,028, filed Nov. 12, 2013, which is incorporated herein by reference in its entirety.

### TECHNICAL FIELD

This disclosure relates to forwarding database implementation for network routing.

### BACKGROUND

Data networks interconnect computing devices and facilitate information exchange. Data centers may include numerous servers addressing internal and external requests over a data network. The requests may be routed to a host for servicing. Data centers may be implemented using a variety of networking topologies.

### BRIEF DESCRIPTION OF THE DRAWINGS

FIG. 1 shows an example network environment.

FIG. 2 shows an example network environment.

FIG. 3 shows an example network environment.

FIG. 4 shows an example network environment.

FIG. 5 shows example logic for route storage.

FIG. 6 shows example logic for message routing.

FIG. 7 show example logic for message routing.

FIG. 8 shows an example network.

FIG. 9 shows an example network.

### DETAILED DESCRIPTION

The disclosure below concerns techniques and architectures for routing lookup in forwarding databases using lookup masks. The lookup masks facilitate exact match database searching for addresses that may be a portion of a full network address. For example, a full network address may include 32 bits and a mask may be applied such that an exact match lookup (EML) is performed on 21 bits of the 32 bits. For example, the 21 most significant bits (MSBs) may be used in the EML. In various implementations, the mask may be applied such that a determined set of bits of the full network address may be used in the EML. For example, a mix of MSBs, least significant bits (LSBs), and/or other bits. Other masks and full address bit lengths may be used. In some cases, the lookup may use a routing classifier (RC) to determine treatment for a routing request based on one or more characteristics of the request.

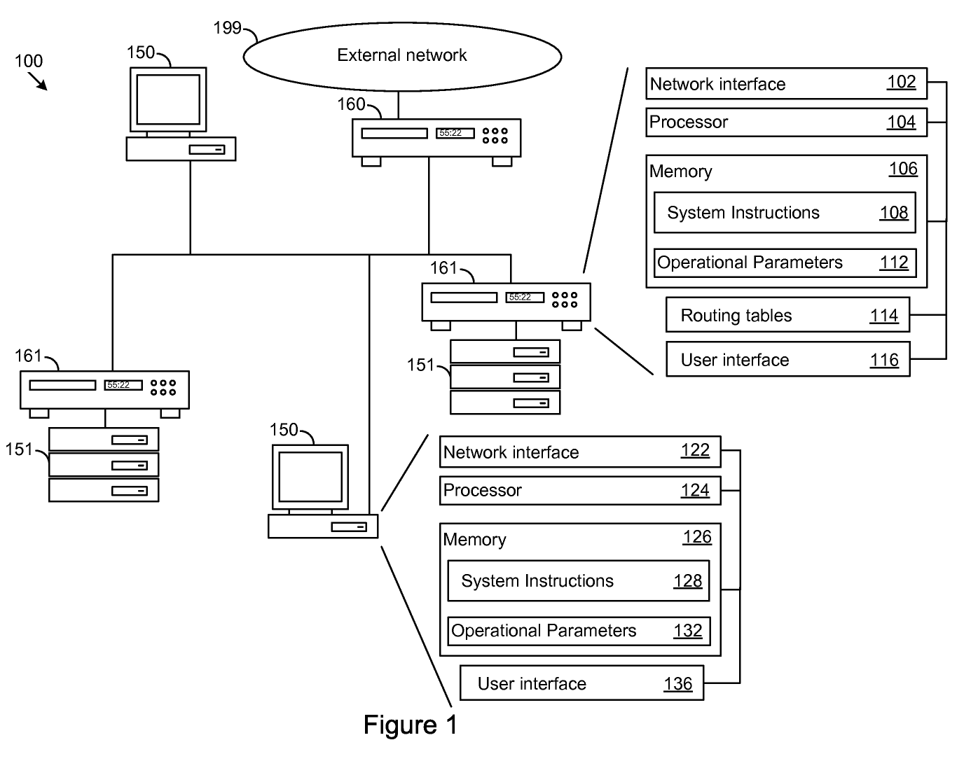

The example device described below provides an example context for explaining the techniques and architectures for routing lookup in forwarding databases using lookup masks. FIG. 1 shows an example network environment 100. For example, the network environment may be a data center. Hosts 150 and rack-mount hosts 151 may be interconnected over the network. The routers 160, 161 may handle switching and traffic forwarding in the network environment 100. The network environment 100 may include connectivity to external networks 199, such as the internet and/or third party networks.

The routers 160, 161 may include network switches, servers, and/or other network infrastructure devices. The hosts 160, 161 may include a network interface 102 to support network communications over one or more protocols, and one or more processors 104 to support execution of applications, routing operations, traffic forwarding and operating systems, and to govern operation of the router 160, 161. The router 160, 161 may include memory 106 for execution support and storage of system instructions 108 and operational parameters 112. The router 160, 161 may include a user interface 116 to allow for user configuration and operation of the router 160, 161. The routers 160, 161 may further include routing tables 114 to support traffic forwarding and database lookup operations. As discussed below, the lookup tables may be configured to support EML, longest prefix match (LPM), and EML via lookup mask.

The hosts 150, 151 may include servers, terminals, and/or other computing devices. The hosts 150, 151 may include a network interface 122 to support network communications over one or more protocols, and one or more processors 124 to support execution of applications and operating systems, and to govern operation of the host 150, 151. The host 150, 151 may include memory 126 for execution support and storage of system instructions 128 and operational parameters 132. The host 150, 151 may include a user interface 136 to allow for user operation of the host.

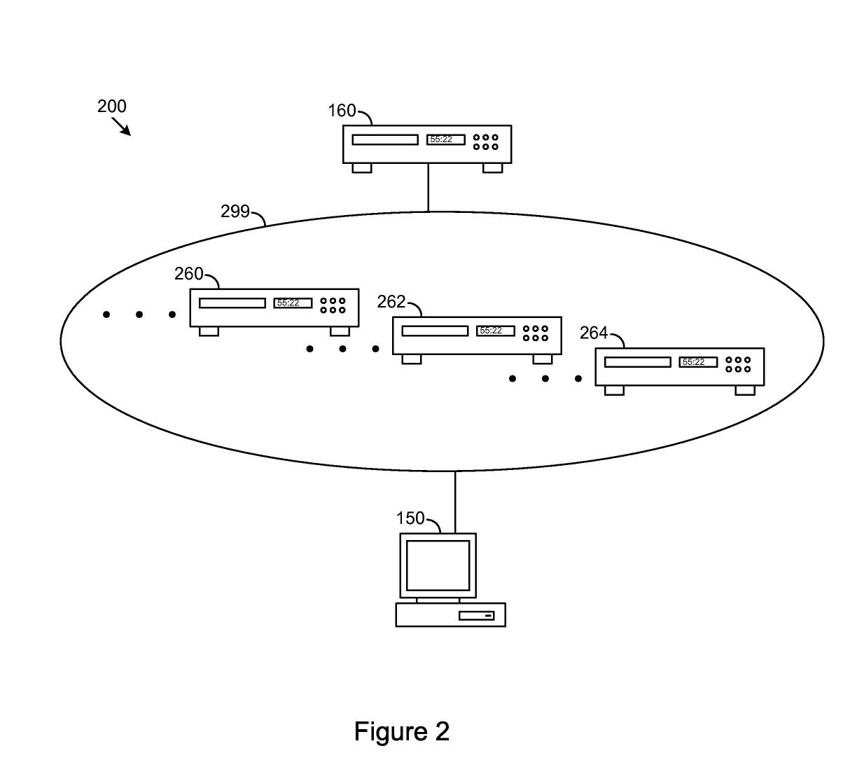

FIG. 2 shows an example network environment 200. In the example network environment 200, a router 160 may receive messages to route to a host 150. The router 160 may be one of multiple steps 260, 262, 264 through a network 299. For a router 160 using full-address EML, the router 160 may store routing information for hosts 150. Once a full-address EML is performed, the router may determine the next step 260 by referencing the entry for the host 150. The number of entries may scale with the number of hosts. Multiple hosts 150 may use a common next step. The router may populate multiple entries for the multiple hosts 150 using a common next step. This may be associated with increased storage usage for large numbers of host 150 entries.

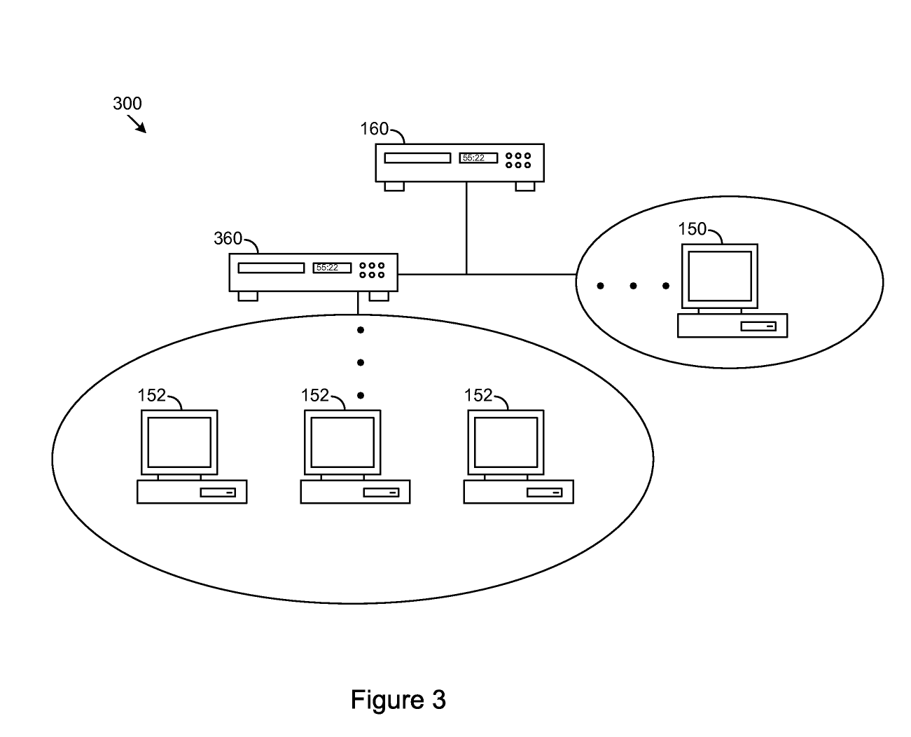

FIG. 3 shows an example network environment 300. In the example network environment 300, a router 160 may receive messages to route to a host 150, 152. Multiple hosts 152 may share a common next step 360. Hosts 150 may be reachable via routes that do not use the next step 360. Further, the addresses of the hosts may share a common portion of their address. For example, a full address may contain 128 bits, i.e. a /128, and the multiple hosts 152 may share 64 common MSBs. For an LPM, the router 160 may store routes associated with prefixes, e.g. groups of MSBs. The router may compare a full-address to the prefixes in its forwarding database to determine which generates the longest match. For example, the prefix in the router's forwarding database associated with a route through next step 360 may generate an 80 bit match with a prefix associated with next step 360. In some cases, the 80 bit match may be the longest prefix match found and the message may be routed through 360. In some cases a 25 bit match may be found with a prefix associated with next step 360. If this is the longest match found, the message may be routed to next step 360. In some cases, the 25 bit match may not be addressed to one of the hosts 152. If the 25-bit match is not the longest match found, the router 160 may forward the message to another step 364. For a longest prefix match, it may not be pre-determined what prefix length may result in a given route. In some cases, a prefix length from 1 bit to the full address length may result in a longest prefix match. The conditional nature of the routing determination may be associated with more storage and processing usage per forwarding database entry for LPM based routing. In some implementations, the per-entry efficiency may be increased by treating distinct address and/or prefixes as not unique, e.g. route coalescing. In some cases, route coalescing may affect the maximum number of hosts that may be addressed. In automated coalescing processes, the effects of coalescing on the maximum number may be unpredictable. Additionally or alternatively, coalescing may affect various subnets, e.g. portions of a network sharing common address MSBs, in differing ways.

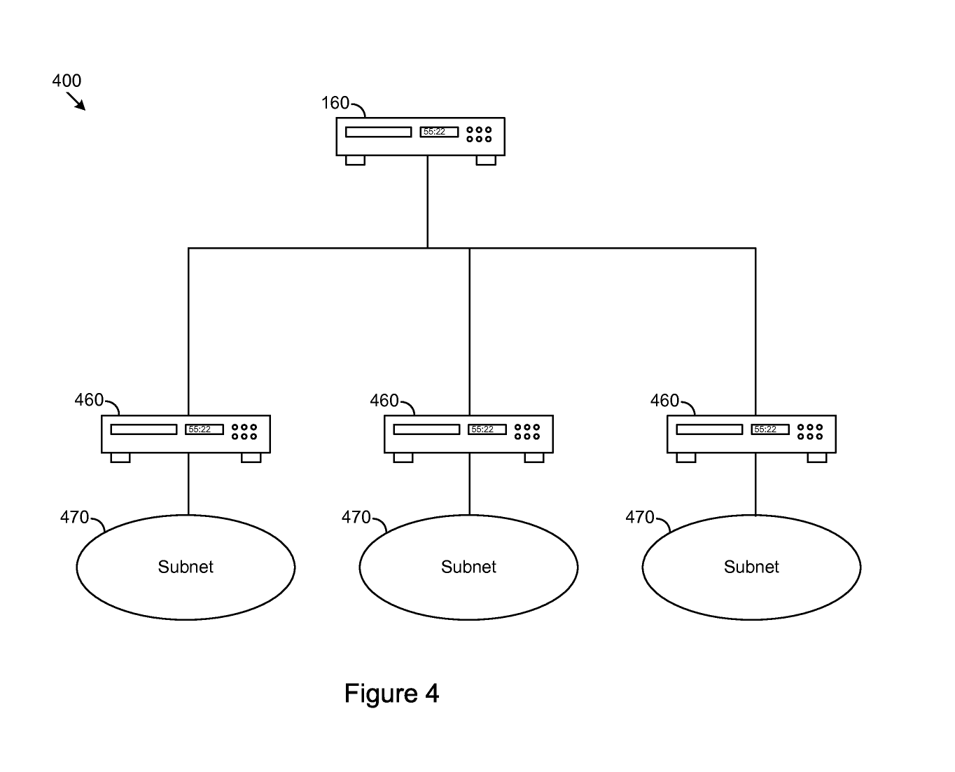

FIG. 4 shows an example network environment 400. In the example network environment 400, a router 160 may send messages to hosts 150, via subnet routers 460. In one implementation, the local subnets 470 below may be represented by addresses that share common bits and may be accessed via the individual subnet routers 460. For example, the subnet routers 460 may be top-of-rack (TOR) routers for a group of servers, e.g. in a datacenter (DC). In some implementations, the router 160 may route traffic through the subnet routers 460 via LPM based on the common bits. The traffic routed to the subnets 470 may traverse the subnet routers 460. The subnet routers 460 from the path to the subnets 470 and therefore LPM may result in traffic being forwarded via the subnet routers 460.

Additionally or alternatively, an address may have a total number of bits, i.e. /N. A mask may be applied to the address such that a portion of the /N may be ignored, replaced with wildcards, or otherwise not included in a routing analysis. In some implementation, replacing bits with wildcards may include marking the bits such that any value in the marked bit position may be considered a match for that bit. Application of the mask may result in an effective /M address where N>M. The router 160 may perform a masked EML (MEML) on the /M address. In some cases, the entry for the /M in the router's 160 forwarding table may be associated with a subnet router 460. The router 160 may forward the message to the subnet router 460 based on the MEML.

In some implementations, the mask may allow for a number of MSBs to be considered in the MEML. The mask may be characterized by a mask length, which is the number of MSBs to be considered in the MEML. The remaining LSBs may be ignored or wild-carded in accord with the mask. In some cases, the mask length may be compared to a LPM prefix length. For situations in which a LPM and MSB MEML produce matches, the route may forward the message in accord with the longer length. For example, if the mask length is shorter than the LPM prefix length, the router may forward the message in accord with the LPM. If the mask length is greater, the router may forward the message in accord with the MSB MEML.

In various implementations, masks may ignore MSBs and consider LSBs in the /M. A mask may be configured to use any portion of the /N to construct a /M. In some cases a router 160 may use multiple masks. The router 160 may implement a RC to determine which of multiple available masks to apply to a given address. In some cases, if a classification for an address is not found, a default mask may be applied and the result of the MEML may be compared to a LPM result to determine the next routing step. For example, a system may use a MSB MEML with a default mask length for comparison with the LPM.

In some implementations, routers 160, 161, 460 may advertise available hosts. In some cases, the routers 160, 161, 460 may list known hosts. The routers may list the known hosts by listing their reachable space and subtractively listing addresses not associated with known hosts.

In some implementations, routers 160, 161, 460 may provide simple advertisements. Routers 160, 161, 460 may list their reachable space of addresses and subtractively list known hosts that are known to be unreachable by the router 160, 161, 460. For example, a router 160, 161, 460 may have connectivity to a group of hosts for a given period. That connectivity may be interrupted. During the interruption, the router 160, 161, 460 knows of the hosts and knows the hosts to be unreachable via the router 160, 161, 460. Thus, the router may subtractively list the hosts to which connectivity was lost. Additionally or alternatively, a router 160, 161, 460 may list a space larger than the router's 160, 161, 460 reachable address space and subtractive list regions of the listed address space that the router cannot reach.

In some cases, such simple advertisement may result in the router advertising addresses that are not associated with known hosts. In some cases, exhaustively subtractively listing addresses not associated with known hosts may increase the size and complexity of an advertisement. In systems of determined and/or regular network topology advertising addresses that are not associated with known hosts, may not affect routing. For example, the locations and addresses of hosts may be known to network operators and/or higher level application layers. The operators and/or higher level application layers may not rely on router advertisement for host resolution services. Router advertisement complexity may be reduced, and the operators and/or higher level application layers may not be affected.

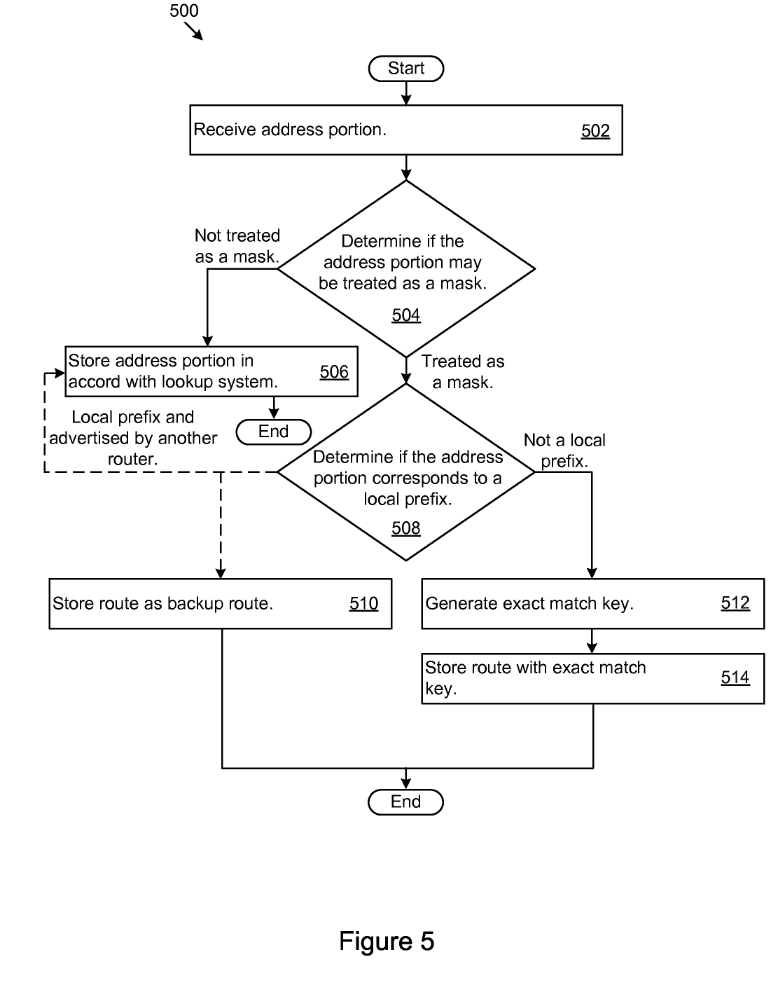

FIG. 5 shows example logic 500 for route storage. The logic 500 may receive a route address portion associated with a route, e.g. a next step (502). In some implementations, a route address portion may include some bits from of a host address from hosts in a given subnet or other host group. For example, the logic 500 may receive an address advertisement from a subnet router 450 that includes an address portion associated with that router. Additionally or alternatively, the logic may receive the route and address portion from a high level process, e.g. an application layer. The logic 500 may determine if the address portion may be used as a mask entry (504). The 504 portion of the logic 500, determination may be implemented in an RC. The logic 500 may include rules for determination if an address portion may be used as a mask entry. For example, the logic may be configured to treat an address portion of a particular length as a mask entry. Additionally or alternatively, an address portion using certain bit positions may be treated as a mask entry by the logic 500. In some cases, the logic 500 may receive an indication from a higher layer process or operator that a given address portion may be treated as a mask entry. If the address portion is determined not to be treated as a mask entry, the address portion may be stored according to a lookup system (506). For example, the address portion and associated route may be stored for LPM routing. If the address portion is a full address, the address portion and associated route may be stored for EML. If the address portion is determined to be treated as a mask entry, the logic may make a determination if the address portion is a local prefix (508). In some cases, a received address portion may be a prefix for a local route. The logic 500 may have a local route table (LRT) of local prefixes. In some implementations, the LRT may include the space listed in the router's reachable address space as discussed above. Additionally or alternatively, if the address portion corresponds a local route and the route is advertised by another router, the logic 500 may store the route (506). In some cases, the router may not store redundant working routes. The route may discard traffic and not forward the traffic along another working route. Additionally or alternatively, the logic may store the route as a backup route in the LRT (510). In some cases, backup routes may not be populated. If the address portion is determined to be treated as a mask entry and is not a local route, the logic may generate an exact match key for the mask entry (512). A received /N may be truncated to create a /M, the /M may be compared the generated exact match key in a MEML. Once an exact match key is created for the mask entry, the received route may be stored with the exact match key (514).

In some implementations, a RC may be implemented with ternary content-addressable memory (TCAM) or other content-addressable memory (CAM). For example, the logic 500 may supply the bits of a /M, /N, or other address portion or bit string, as a search term and the RC, e.g. TCAM or CAM implemented, may return entries from the router's forwarding database and/or LRT including the search term. In some cases, e.g. with a TCAM implemented RC, the search term length may be allowed to vary or may be included as a search term. This may allow the RC to determine which of multiple masks of varying length and bit positions may be applied to a received address. Additionally or alternatively, the RC may allow for classification of received routes by matching prefixes or other received address portions to mask types used by the logic 500.

In various implementations, a group of subnets associated with equal length prefixes, e.g. some number of MSBs from the host addresses of the hosts in the subnets, may have their prefixes treated as mask entries by the logic 500. For example, TOR routers in the datacenter may be configured to have equal length prefixes. The routers 160 in the datacenter may be configured to treat prefixes matching the TOR router length as mask entries.

In some cases, route coalescing may be applied. Multiple longer prefixes may be combined into a shorter prefix, e.g. if the longer prefixes share routing characteristics. Additionally or alternatively, the shorter prefix may be accompanied by a prefix of the longer length that lists exceptions to the shorter prefix. Received prefixes may be separately considered by the logic 500 to optimize storage. In some cases, it may be advantageous to avoid coalescing exact match entries into LPM entries because exact match entries use fewer resources. An aggregation heuristic may be applied. For example, at least 8, 16, 32 or other number of exact match entries may be coalesced to form a LPM entry.

In some cases, shorter prefixes may be broken into multiple longer prefixes. For example, this reverse coalescing may be implemented if some TOR routers in a DC have shorter prefixes than other TOR routers in the DC.

In various implementations, routers 160 may receive local traffic and route the traffic remotely or locally. For example a local location may be a host within the router's subnet, and a remote location may be a location outside the router's subnet. Additionally or alternatively, routers may receive remote traffic and route it locally or remotely.

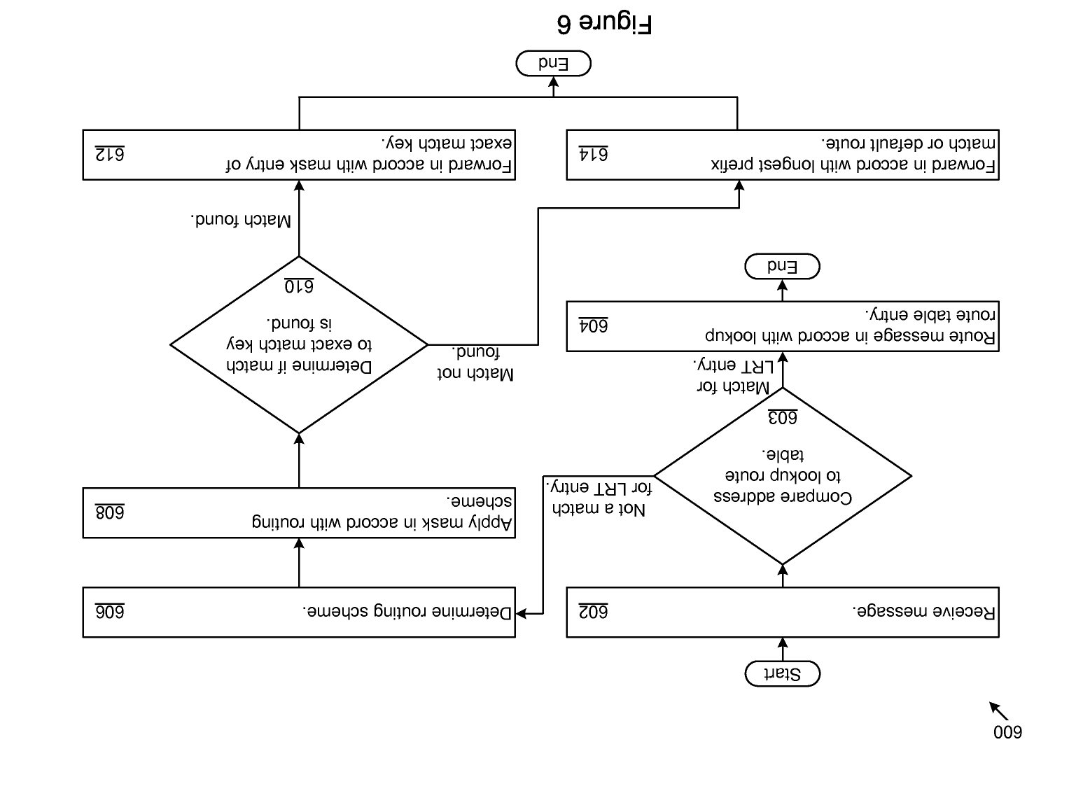

FIG. 6 shows example logic 600 for message routing. A router, e.g. 160, 161, 460, may receive a message with a routing address (602). The logic 600 may compare the address to a LRT for the router (603). If the address is matched to a LRT entry, e.g. an EML or LPM, the address may be routed in accord with the LRT entry (604). If the address does not match an LRT entry, the logic 600 may determine a routing scheme for the address (606). For example, the logic 600 may implement a RC to determine if a selected mask of the masks used by the router may be applied to the address. Once a routing scheme is determined, a mask may be applied to the address in accord with the scheme to produce a /M (608). The logic may determine if an MEML of /M produces a match with any of the exact match keys of the router (610). If a match is found, the message may be routed in accord with the mask entry of the exact match key (612). If a match is not found, the message may be forwarded in accord with a default route or a LPM route (614).

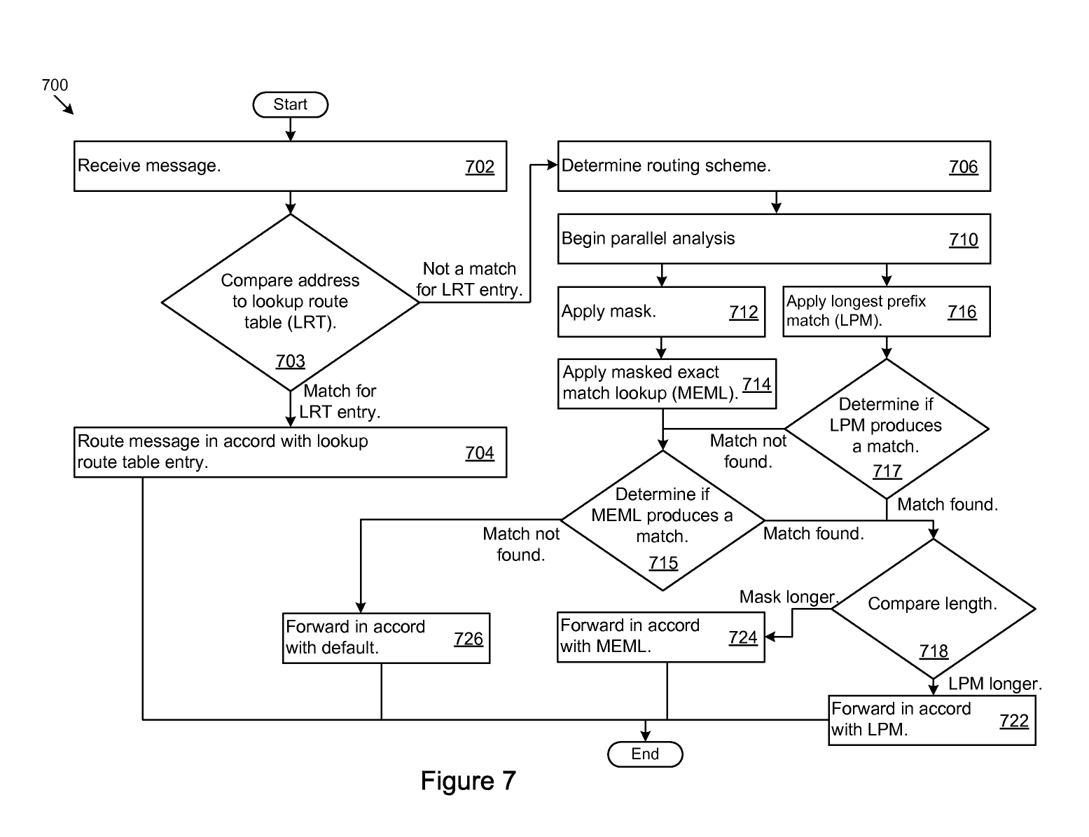

FIG. 7 show example logic 700 for message routing. A router, e.g. 160, 161, 460, may receive a message with a routing address (702). The logic 700 may compare the address to a LRT for the router (703). If the address is matched to a LRT entry, e.g. an EML or LPM, the address may be routed in accord with the LRT entry (704). If the address does not match an LRT entry, the logic 700 may determine a routing scheme for the address (706). For example, the logic 700 may implement a RC to determine if a selected mask of the masks used by the router may be applied to the address. Once a routing scheme is determined, a parallel MEML and LPM analysis may be implemented (710). A selected mask may be applied to the /N to generate a /M (712). A MEML may be applied to the /M (714). The logic 700 may determine if the MEML produces a match (715). A LPM may be applied to the /N (716). The logic 700 may determine if the LPM produces a match (717). The length of the LPM prefix may be compared to the length of the /M (718). If the MEML produces a match, the message may be forwarded in accord with the longer of the /M and the LPM prefix. For equal lengths, the logic 700 may route the message in accord with the higher priority match. For example, the router's forwarding database entries may indicate a priority level. Additionally or alternatively, a rule may guide priority. For example, LPM prefixes may be given higher priority than MEML matches. If the MEML does not produce a match, the message may be forwarded in accord with the LPM prefix (722). If the LPM does not produce a match, the message may be forwarded in accord with the MEML (724), e.g. if a MEML match is found, or a default route (726).

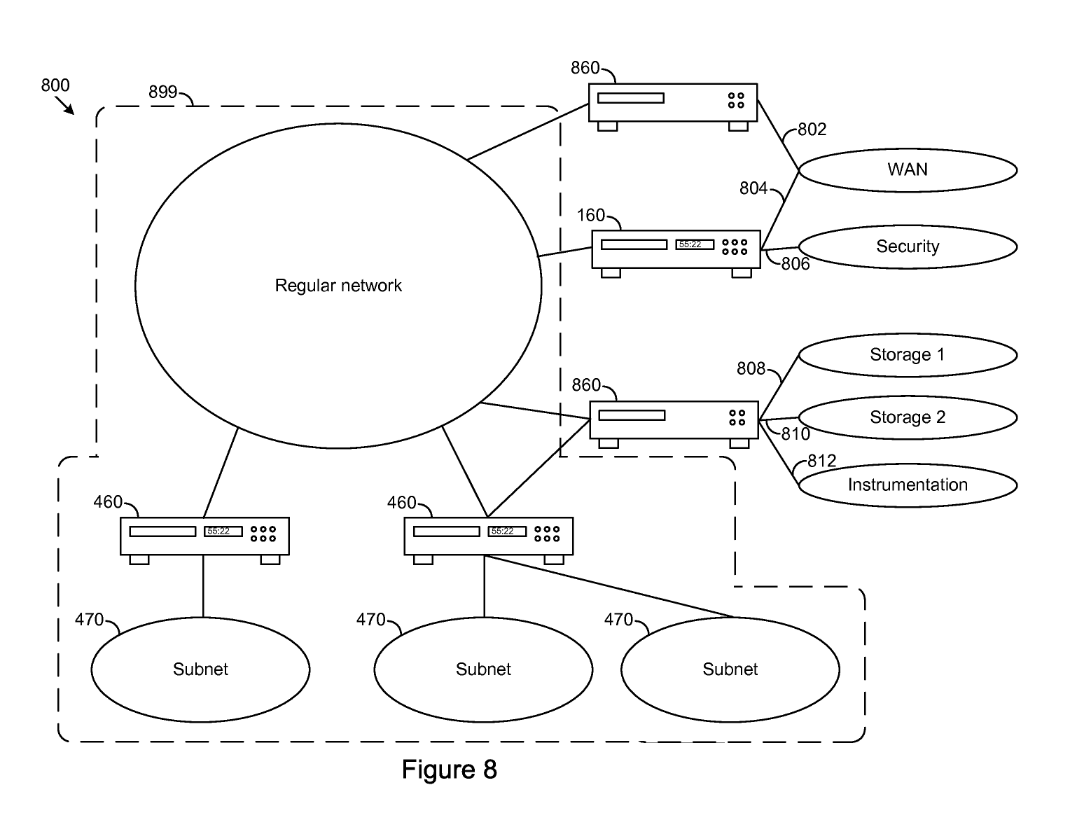

FIG. 8 shows an example network 800. In the example network 800, routers 160 subnet routers 460, and legacy routers 860 may be implemented. The subnet routers 460 may have subnets with prefixes of equal length. The routers 160, 460 may be able to forward messages to routers 160, 460 and legacy routers 860 using MEML. The legacy routers 860 may use EML and/or LPM for routing activity. The example network 800 may have connections 802, 804, 806, 808, 810, 812 to external networks. For example, the external networks may include wide area networks (WANs), dual-homed, e.g. redundant, WAN access, security networks, storage networks, and instrumentation networks. In some cases, the network 800 may include a regular portion 899 including routers 160, 460 configured to used MEML forwarding and simple advertisements. For example, the regular portion 899 may interconnect computing elements in a data center. In some cases, the network topology of the regular portion 899 may be known to a network operator or management entity. The routers 160, 460 configured for MEML may maintain entries for forwarding messages to external networks. In some cases, the routers in the regular portion 899 may use default routes for routing messages to the external networks. In some cases, the regular portion 899 may include a large number of hosts. The legacy routers 860 may maintain a large forwarding database of LPM and exact match entries to address the hosts in the regular portion.

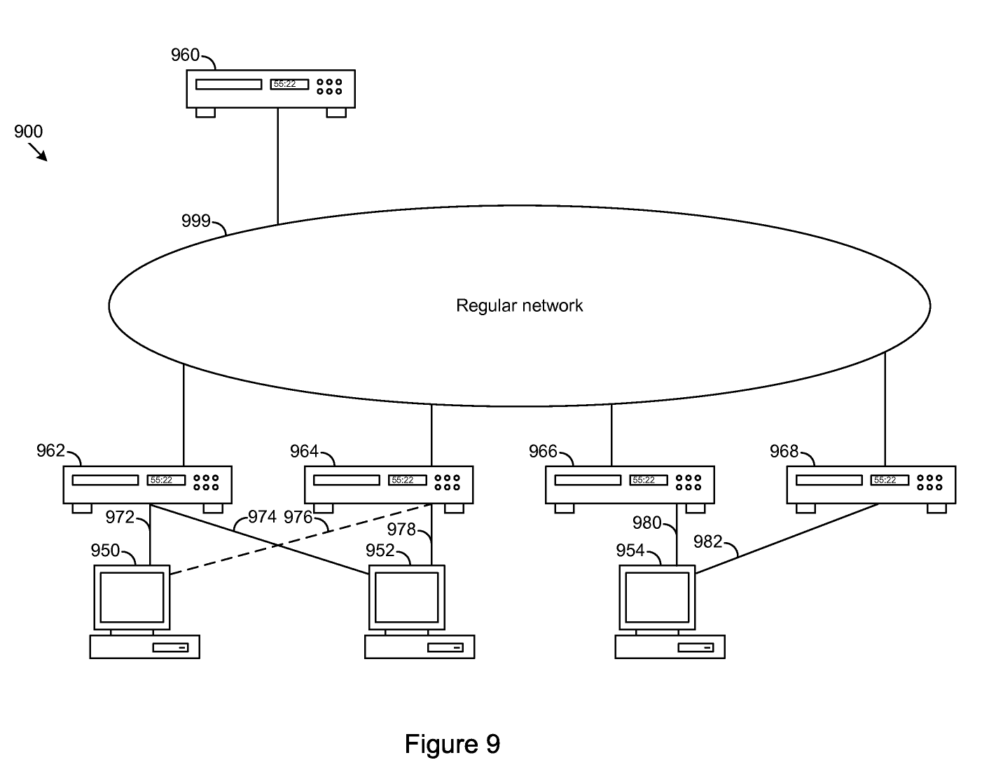

FIG. 9 shows an example network 900. The example network 900 includes multiple dual-homed hosts 950, 952, 954. In the example network the dual-homed hosts 950, 952, 954 are accessible through multiple links 972, 974, 976, 978, 980, 982, 984, 986 of routers 962, 964, 966, 968. For example, a message forwarded from router 960 to host 950 via a regular portion 999 of the network 900 may traverse router 962 and/or router 964. Further, routers 962, 964 may advertise an address space including host 950. Routers 962, 964 may include entries in their LRTs for hosts 950, 952. Routers 966, 968 may include entries in their LRTs for host 954. In some cases routers 962, 964, 966, 968 may coalesce entries in their LRTs. Hosts 950, 952 may use routers 962, 964 to reach remote destinations. For example, host 950 may use routers 962, 966 to reach host 954. In some cases, routers 962, 964, 966, 968 may include MEML routing entries in their forwarding tables for others of routers 962, 964, 966, 968. In some cases the MEML routing entries may include address prefixes (MSB address portions). Additionally or alternatively, the routers 962, 964, 966, 968 may populate backup routes to dual-homed hosts 950, 952, 954 in the router's 962, 964, 966, 968 LRTs. If a local route to a host 950, 952, 954 is lost, the backup LRT entry may be implemented. Additionally or alternatively, routers 962, 964, 966, 968 may include MEML routing entries for router 960. In some cases, the MEML entries for router 960 may include portions with various bit positions (e.g. MSBs, LSBs, central address bits, and/or a combination of bit types. In some cases, the routers 960, 962, 964, 966, 968 may receive and/or forward messages using MEML, EML and/or LPM based routing.

In some cases, a link 972, 974, 976, 978, 980, 982, 984, 986 may be interrupted, e.g. go offline. For example, link 976 between host 950 and router 964 may be interrupted. Router 964 may implement a backup route based on a backup entry for host 950 in the LRT of the router 964. For example, the router 964 may use an LPM route through router 962 to route around interrupted link 976. In some cases, router 964 may not list host 950 in its advertised reachable address space when link 976 is interrupted. For example host 950 or a space including host 950 may be subtractively lists from the reachable address space of router 964.

The methods, devices, and logic described above may be implemented in many different ways in many different combinations of hardware, software or both hardware and software. For example, all or parts of the system may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. All or part of the logic described above may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above.

Various implementations have been specifically described. However, many other implementations are also possible.

What is claimed is:

1. A method, comprising:
receiving, at a router, a message comprising a routing address;
determining a mask length for a mask;
applying the mask in accord with the mask length to the routing address to determine a masked address; and
performing an exact match on the masked address.

2. The method of claim 1, further comprising, routing the message in accordance with the exact match on the masked address.

3. The method of claim 1, further comprising:
comparing the mask length and a longest prefix length; and
in response to the comparison, routing the message in accordance with a longest prefix match.

4. The method of claim 1, further comprising comparing the address to a local prefix for the router.

5. The method of claim 4, where the local routing prefix is associated with a determined routing action listed in a local route table.

6. The method of claim 5, where the local route table includes listings for multiple protocols.

7. The method of claim 1, further comprising storing a route for the exact match of the masked address.

8. The method of claim 7, where storing the route comprises storing the route with an exact match key for the exact match of the masked address.

9. The method of claim 1, further comprising determining a source of the message in accordance with the exact match on the masked address.

10. The method of claim 1, further comprising classifying the address via a routing classifier, to determine a routing type.

11. The method of claim 10, where performing the exact match on the masked address comprises, responsive to the classification:
performing the exact match on a first bit of the address; and
applying a wildcard to a most significant bit different from the first bit.

12. An apparatus, comprising:
a network interface configured to:
receive a message comprising a routing address; and
forward the message in accord with a route; and
logic, operatively connected to the network interface, the logic configured to:
apply a mask to the routing address to determine a masked address; and
perform an exact match on the masked address.

13. The apparatus of claim 12, where the logic is further configured to:
determine an exact match length for the exact match;
perform a longest prefix match on the routing address to determine a longest prefix length;
when the longest prefix length is longer than the exact match length, determine the route in accord with the longest prefix match; and
when the longest prefix length is shorter than the exact match length, determine the route in accord with the exact match.

14. The apparatus of claim 12, where:
the routing address comprises a first bit and a second bit; and
the logic is further configured to:
apply a wildcard to the first bit to apply the mask; and
perform the exact match on the second bit.

15. The apparatus of claim 14, where:
the first bit comprises a most significant bit; and
the second bit is different from the first.

16. The apparatus of claim 14, where:
the second bit comprises a most significant bit; and
the second bit is different from the first.

17. The apparatus of claim 12, further comprising a local route table; and
where the logic is further configured to compare the routing address to a local route prefix associated with an entry in the local route table.

18. A method, comprising:
receiving, at a router, a message comprising a routing address;
performing a longest prefix match on the routing address to determine a longest prefix length;
applying a mask to the routing address to determine a masked address;
performing an exact match on the masked address;
determining a mask length for the mask; and
comparing the mask length and the longest prefix length.

19. The method of claim 18, where performing the exact match on the masked address comprises determining an exact match key associated with a stored exact match route.

20. The method of claim 19, further comprising forwarding the message in accord with the stored exact match route responsive to the comparison.
